(19) United States
(12) Patent Application Publication
(10) Pub. No.: US 2006/0220536 A1
(43) Pub. Date: Oct. 5, 2006

(54) Organic electroluminescent device and method of manufacturing the same

(76) Inventors: Wen-Jeng Lan, Chu-Nan (TW); Chien-Yuan Feng, Chu-Nan (TW); Yuan-Chang Tseng, Chu-Nan (TW); Ting-Chou Chen, Chu-Nan (TW); Sheng-Hsu Shih, Chu-Nan (TW); Chien-Chih Chiang, Chu-Nan (TW); Chih-Ping Lin, Chu-Nan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/392,791

(22) Filed: Mar. 30, 2006

(30) Foreign Application Priority Data
Apr. 1, 2005 (TW) 094110592

(51) Int. Cl. H05B 33/00

(52) U.S. Cl. 313/504; 313/506

(57) ABSTRACT

An organic electroluminescent device and method of manufacturing the same are provided. The device comprises a plurality of lower electrodes and at least one insulation layer crossing said lower electrodes. The insulation layer consists of parts of a bottom, a neck, and a top, wherein the action width of the top thereof is smaller than the bottom, which when such formed as a organic light emitting layer, the organic light emitting layer can touch the bottom of the insulation layer to prevent the short circuit from the abnormal contact of the opposite electrode and lower electrode. Further, a separator can be formed between each of the lower electrodes. The separator and the insulation layer can define each pixel position within the organic electroluminescent device. Wherein, the separator can isolate the horizontal light source of the organic light emitting layer to reduce the crosstalk noise for pixels each other.

### FIELD OF THE INVENTION

The present invention relates to an organic electroluminescent device and method of manufacturing the same, not only preventing to cause the short circuit from the abnormal contact of the opposite electrode and lower electrode, but also defining each pixel position and reducing the crosstalk noise for pixels each other.

### BACKGROUND OF THE INVENTION

As the development of optical storage industry, people enjoy the convenience of the technology. However, how to design a flat panel displayer or light emitting device with high definition and low cost is a final purpose for each famous manufacture. In view of many displayers and light emitting devices, the organic electroluminescent device (such as OLED) provides many advantages as self-illumination, high brightness, wide viewing angle, low power consumption, high response speed, and thin panel, which is surely paid attention by every manufacture and research institution.

In accordance with a general organic electroluminescent device 10, as shown on FIG. 1 and FIG. 2, comprises a lower electrode 13 provided on the partial surface of a transparent substrate 11; a insulation layer 15 crossing the lower electrode 13, provided on the transparent substrate 11 and the partial surface of the lower electrode 13. The top of the insulation layer 15 further comprises a convex edge 151, which the action width thereof is bigger than the insulation layer 15. The convex edge 151 is provided as a sheltering device while the organic light emitting layer 17 and an opposite electrode 19 are growing within the further process, which can advantage the position definition and formed for the organic light emitting layer 17 and the opposite electrode 19.

According to the insulation layer 15 and the convex edge 151 provided, that is with easier definition and the organic light emitting layer 17 and opposite electrode 19 formed. But, when the organic light emitting layer 17 and opposite electrode 19 grow carelessly, the opposite electrode 19 will bring a spilled area 191 over the border 171 of the organic light emitting layer 17. The spilled area 191 can cause the short circuit according to the contact of the opposite electrode 19 and the lower electrode 13. In other word, the organic light emitting layer cannot be emitted normally, and causing the bright dots and dark dots within the organic electroluminescent device 10.

Further, within the structure of the prior art organic electroluminescent device 10, only provides the corresponding power-on status from the lower electrode 13 and the opposite electrode 19 to decide whether emitting light by the organic light emitting layer 17 (or as the pixel) in such area, and achieves the purpose of light emitting area and pixel definition. However, the prior art organic electroluminescent device 10 cannot clearly define and limit the light emitting area of the organic light emitting layer 17. Therefore, as displaying by each pixel, each of the pixels may noises each other by the horizontal light source thereof, which is so called the crosstalk, affecting the display by the organic electroluminescent device 10.

### SUMMARY OF THE INVENTION

Accordingly, how to design a novel organic electroluminescent device and method of manufacturing the same with respect to the previous mentioned shortcomings of the prior art, preventing the short circuit from the lower electrode and the opposite electrode, and solving the defect of the crosstalk from the pixels each other by simpler manufacturing is the key point of the present invention. Therefore,

It is a primary object of the present invention to provide an organic electroluminescent device, comprising at least one insulation layer with the action width of the bottom thereof is bigger than the top, provided on the transparent substrate and the partial surface of the lower electrode, which not only correctly positions for the organic light emitting layer and the opposite electrode, but also prevents the short circuit from the abnormal contact of the lower electrode and the opposite electrode.

It is a secondary object of the present invention to provide an organic electroluminescent device for defining each light emitting area and the correct position of each pixel and reducing the crosstalk from the pixels each other according to an insulation layer and a separator.

It is another object of the present invention to provide a method of manufacturing an organic electroluminescent device for defining and forming the insulation layer and the separator by simple semiconductor manufacturing method, which not only prevents the short circuit from the abnormal contact of the lower electrode and the opposite electrode, but also reduces the defect of the crosstalk from the pixels each other.

To achieve the previous mentioned objects, the present invention provides an organic electroluminescent device, comprising a transparent substrate, comprising at least one lower electrode provided on the partial surface thereof; at least one insulation layer convexly provided on the transparent substrate and the partial surface of the lower electrode, crossing the lower electrode and forming as an intersection type with the lower electrode; at least one separator provided on the surface of the transparent substrate without the lower electrode and the insulation layer; and an organic light emitting layer provided on the surface of the lower electrode without the insulation layer sheltering, further comprising an opposite electrode provided on the surface of the organic light emitting layer.

To achieve the previous mentioned objects, the present invention further provides a method of manufacturing organic electroluminescent device, comprising the steps of defining and forming at least one lower electrode provided on the partial surface of a transparent substrate; covering an isolating layer provided on the surface of the lower electrode and the transparent substrate without the lower electrode sheltering, defining and forming at least one insulation layer, which is used to be an intersection type with the lower electrode, and a separator adjoined on the lower electrode within at least one semiconductor process and providing on an isolating layer, according to a photoresist and a short wavelength light source applied; and forming at least one organic light emitting layer and at least one opposite electrode provided on the surface of the lower electrode in order.

### BRIEF DESCRIPTION OF THE DRAWINGS

It will be understood that the figures are not to scale since the individual layers are too thin and the thickness differences of various layers too great to permit depiction to scale.

FIG. 1 is a three-dimensional view of a prior art organic electroluminescent device;

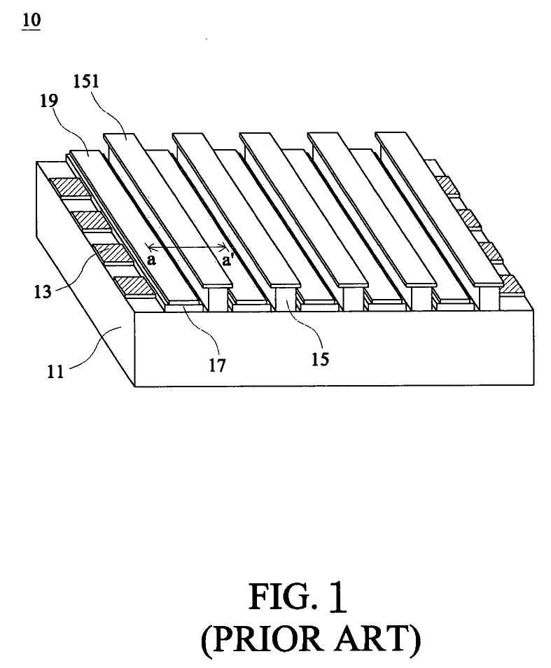

FIG. 2 is partial cross-sectional view of the prior art organic electroluminescent device;

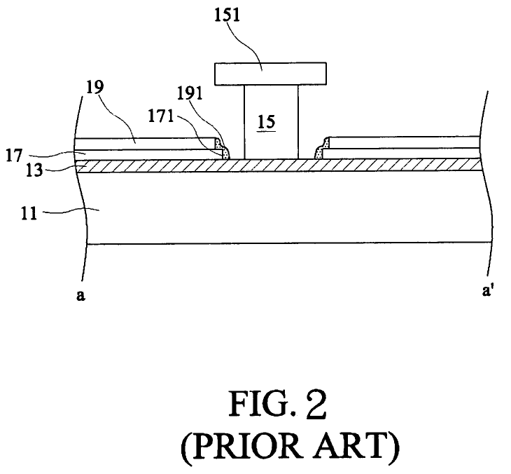

FIG. 3 is a three-dimensional view of a preferred embodiment of the present invention organic electroluminescent device within manufacturing;

FIG. 4 is a three-dimensional view of the preferred embodiment of the present invention organic electroluminescent device as completely manufacturing;

FIG. 4A and FIG. 4B are respectively the partial cross-sectional views of the preferred embodiment of the present invention organic electroluminescent device;

FIG. 5A to FIG. 5D are respectively the three-dimensional views of the preferred embodiment of the present invention organic electroluminescent device within manufacturing by each process step;

FIG. 6A and FIG. 6B are respectively the partial cross-sectional views of the preferred embodiment of the present invention within manufacturing by each process step;

FIG. 7 is the partial cross-sectional views of another preferred embodiment of the present invention; and

FIG. 8 is a structure vertical view of another preferred embodiment of the present invention.

### DETAILED DESCRIPTION OF THE INVENTION

The structural features and the effects to be achieved may further be understood and appreciated by reference to the presently preferred embodiments together with the detailed description.

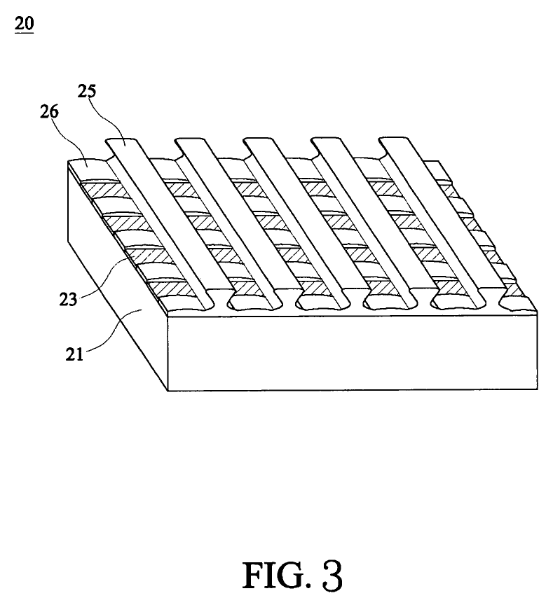

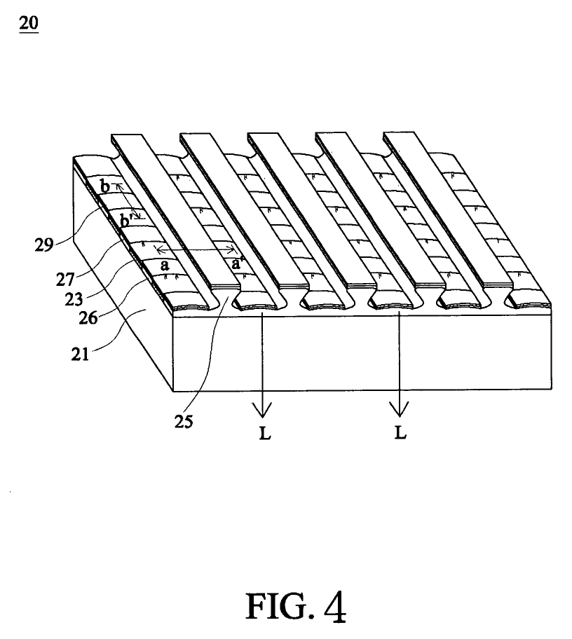

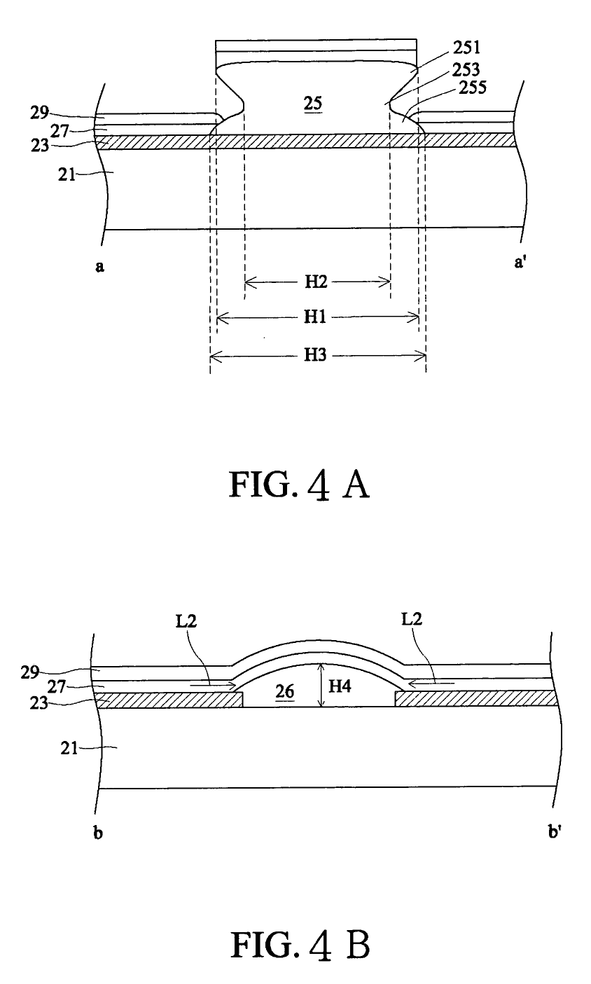

Referring to FIG. 3, FIG. 4, FIG. 4A, and FIG. 4B, are respectively a three-dimensional view of a preferred embodiment of the present invention organic electroluminescent device within manufacturing; a three-dimensional view of the preferred embodiment of the present invention organic electroluminescent device as completely manufacturing; and the partial cross-sectional views of the preferred embodiment of the present invention organic electroluminescent device. The organic electroluminescent device 20 comprises at least one lower electrode 23 provided on the surface of a transparent substrate 21, at least one insulation layer 25 crossing the lower electrode 23, provided on the transparent substrate 21 and the partial surface of the lower electrode 23. The insulation layer 25 consists of a bottom 255 connecting to a top 251 through a neck 253. The bottom 255 connects to the partial transparent substrate 21 and lower electrode 23. The action width H3 of the bottom 255 and the action width H1 of the top 251 are bigger than the action width H2 of the neck H2. And, the device 20 further comprises at least one separator 26 provided on the surface of the transparent substrate 21 without the lower electrode 23 and the insulation layer 25. In other word, the separator can be formed between each of two lower electrodes 23, and the border of the separator 26 is contacted with the lower electrode 23. The insulation layer 25 and the separator 26 can be used to define the light emitting area (or called as pixels) of the organic electroluminescent device 25, as shown on FIG. 3.

The lower electrode 23 without the insulation layer 25 sheltering, the insulation layer 25, and the surface of the separator 26 are grown an organic light emitting layer 27 and an opposite electrode 29 in order. Supplying power to the organic light emitting layer 27 from the lower electrode 23 and the opposite electrode 29, and controlling the light emitting area of the organic electroluminescent device 20 can achieve the purpose of lighting or displaying by the organic electroluminescent device 20.

In accordance with the action width H1 of the top 251 of the insulation layer 25 is bigger than the action width H2 of the neck of the insulation layer 25. Therefore, as forming the organic light emitting layer 27 and the opposite electrode 29, the top 251 can be as the structure of the convex edge 151 of the insulation layer (15) of the prior art, which may advantage the correct positioning and forming of the organic light emitting layer 27 and the opposite electrode 29.

Further, the action width H3 of the bottom 255 of the insulation layer 25 can be selected to be bigger than the action width H1 of the top 251 of the insulation layer 25. Therefore, as forming the organic light emitting layer 27, the edge of the organic light emitting layer 27 can be touched with the bottom 255 of the insulation layer 25, or stacked on the surface of the bottom 255, as shown on FIG. 4A. Wherein, forms a protection layer according to the connection of the organic light emitting layer 27 and the bottom 255 of the insulation layer 25, that is, once the forming of the opposite electrode 29 causes the alignment fault, the abnormal contact of the opposite electrode 29 and the lower electrode 23 can be eliminated completely.

The emission light source L generated by the organic electroluminescent device 20 passes through the lower electrode 23 and transparent substrate 21 from the organic light emitting layer 27 to the outside of the organic electroluminescent device 20. Therefore, the light emitting area (pixel) can be easily defined by the insulation layer 25 and the separator 26 provided. And, the height of the separator 26 can resist the horizontal light source L2 generated by the organic light emitting layer 27, wherein the horizontal light source L2 may affect the adjacent organic light emitting layer 27. Such that, the light emitting field of the emission light source L generated by each organic light emitting layer 27 can be limited to reduce the crosstalk problem from the organic light emitting layers 27 or pixels each other. Surely, the height of the separator 26 won't block to form the organic light emitting layer 27 and the opposite electrode 29.

The insulation layer 25 and said separator 26 can be selectively made by a non electrical conductive material, such as silicon oxide, silicon nitride, nitrided silicon dioxide, polyidmide, ketoaldehyde resin, phenolic resin, and polymethyl methacrylate.

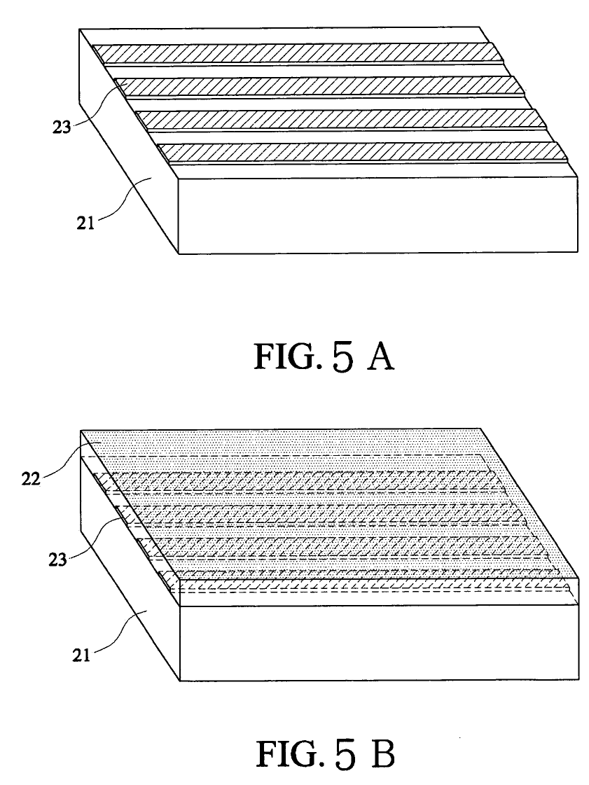

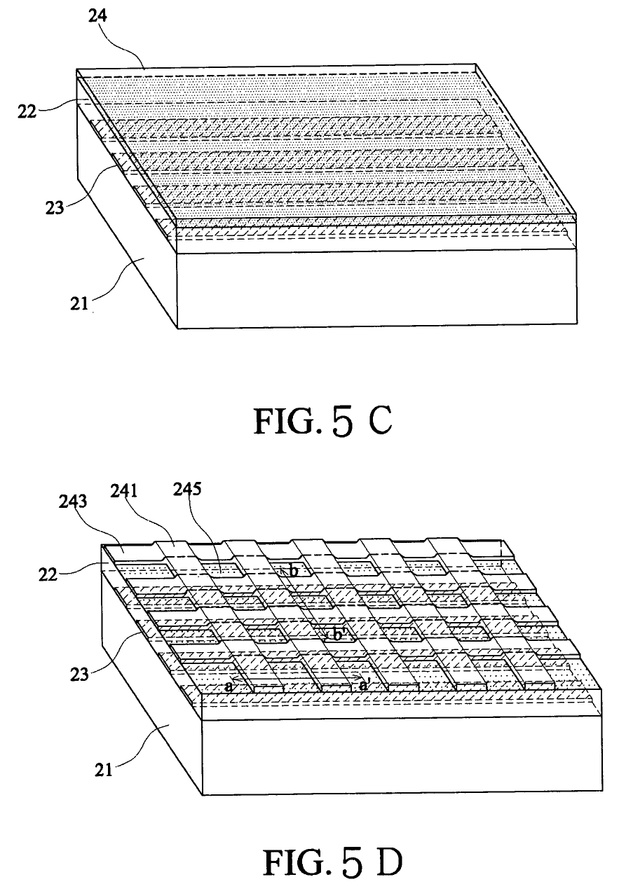

Referring to the FIG. 5A to FIG. 5D, and FIG. 6A to FIG. 6B, are respectively a three-dimensional view and a cross-sectional view of a preferred embodiment of the present invention organic electroluminescent device within manufacturing by each process step. The flow of manufacturing the organic electroluminescent device 20 is as following steps. Firstly, to define and form at least one lower electrode 23 on the surface of a clear transparent substrate 21 by photo lithography and etching process within the semiconductor process is as shown on the FIG. 5A.

After the lower electrode 23 providing on the partial surface of the transparent substrate 21, an even isolating layer 22 can be grown on the lower electrode 23 and the surface of the transparent substrate 21 without the lower electrode 23 as shown on the FIG. 5B.

Consequently, to define and form at least one insulation layer 25 and at least one separator 26 provided on the isolating layer 22, the surface of the isolating layer 22 being evenly coated by a photoresist 24 is as shown on the FIG. 5C.

And, the insulation layer 25 and separator 26 can be formed by a semiconductor process. For example, according to a light shield corresponding to a fixed attitude of the short wavelength light source, wherein the light penetration rate of the light shield can be alternated by the position difference of light penetrating, or according to a short wavelength light source corresponding to a light shield, wherein the light attitude of the short wavelength light source can be alternated by the angle difference, the exposure process can be achieved. Wherein, the wavelength of the short wavelength light source can be selected to be smaller than 500 nm. The thickness of the photoresist 24 provided after lithography process leaving can be controlled by alternating the attitude of the short wavelength light source. The thickness difference of the leaving photoresist 24 may affect the etching thickness of the isolating layer within further process. For example, a thicker first photoresist 241 is formed on the position for the insulation layer 25 reserved, a complete protection for the isolating layer 22 sheltered by the first photoresist 241 is provided while the further wet etching process proceeds, according to the complete structure and the thickness of the first photoresist 241, such that, the isolating layer 22 sheltered by the first photoresist 241 can be formed as a insulation layer 25 after finishing the wet etching process, as shown on the FIG. 6A.

A thinner second photoresist 243 is formed on the position for the separator 26 reserved. The second photoresist 243 will protect the isolating layer 22 sheltered thereby during the front period of the further wet etching process. However, the structure and thickness of the second photoresist 243 are too weak, the photoresist 243 may be etched to peel off by etching liquid after a period of time within the wet etching process proceeding. After the second photoresist 243 peeled off, the etching liquid will etch the isolating layer 22 sheltered by the second photoresist 243. The isolating layer 22 sheltered by the second photoresist 243 can be formed as a separator 26 after the wet etching process finishing, wherein the height H4 of separator 26 is lower than the height H5 of the insulation layer 25, as shown on the FIG. 6B. The insulation layer 25 and separator 26 can be formed on the transparent substrate 21 by the previous mentioned semiconductor process, as shown on the FIG. 3.

An etching window 245 is formed on the position for the organic light emitting layer 27 and the opposite electrode 29 reserved, advantaging for removing the partial corresponding photoresist 24 to expose the partial lower electrode 23 within the further etching process.

Beside, the definition of the light emitting area (pixel) of the organic electroluminescent device 20 will be finished after the insulation layer 25 and the separator forming. After that, the growing of the organic light emitting layer 27 will be going. The action width H1 of the top 251 of the insulation layer 25 is bigger than the action width H2 of the neck 253 of the insulation layer 25. Therefore, when the organic light emitting layer is growing, the top 251 will be formed as a sheltering device. The organic light emitting layer 27 can be defined and distinguished within each position thereof. And, the action width H3 of the bottom 255 of the insulation layer 25 is bigger than the action width H2 of the neck 253 of the insulation layer 25. The edge of the organic light emitting layer 27 will touch or stack directly with the bottom of the insulation layer 25. Such that, regardless of the opposite electrode further growing, that cannot be touched the lower electrode 23 in anyway.

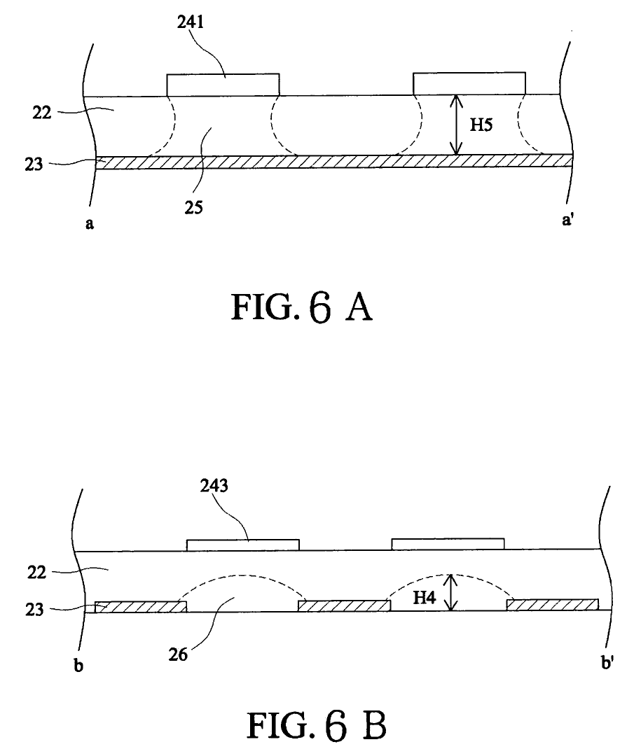

With in general process, the first photoresist 241 provided on the surface of the insulation layer 25 will be removed by liquid photoresist before the organic light emitting layer 27 forming to advantage the further processing, as shown on the FIG. 4A. However, in view of another preferred embodiment of the present invention, the first photoresist 241 cannot be removed also. The organic light emitting layer 27 and the opposite electrode 29 are formed on the surface of the first photoresist 241 directly, as shown on the FIG. 7, which will not affect the application of the organic electroluminescent device 20, and simplify the manufacturing process thereof.

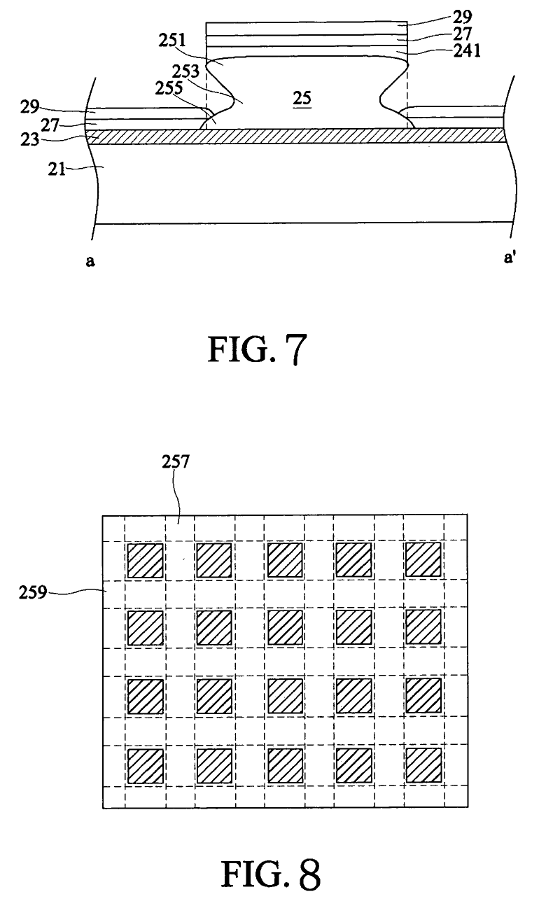

Referring to FIG. 8, is a structure vertical view of another preferred embodiment of the present invention. As the previous mentioned manufacturing process, the insulation layer 25 and the separator 26 are defined and formed by single lithography and etching process, however, in fact, such can be defined and formed by multiple times lithography and etching process. For example, firstly, the photoresist 24 sheltered on the surface of the isolating layer 22 is proceeded by the first lithography. And, such lights the photoresist 24 in a short wavelength light source with a fixed attitude to equalize the thickness of the photoresist 24 leaving from the lithography process on the isolating layer 22. In the meantime, the first etching is going. The first etching process is a wet etching process. After finishing the wet etching process, the isolating layer 22 can be formed as at least one first insulation layer 257 and at least one second insulation layer 259, wherein the second insulation layer 259 is as an intersection type with the first insulation layer 257, and the height of the second insulation layer 259 equals the first insulation layer 257.

Forwarding to second lithography process, that defines an etching area for one of the first insulation layer 257 and the second insulation layer 259. For example, such forms the photoresist 24 on the surface of the first insulation layer 257, and proceeds the second etching (wet etching) process, the wet etching process is only used to etch the second insulation layer 259, which the surface thereof is without the photoresist 24 sheltering. Therefore, the second insulation layer 259 will be etched as the separator 26, such that, achieves the purpose of defining and forming the insulation layer 25 and the separator 26.

Within the previous mentioned etching process, the first etching and the second etching process are to proceed with wet etching process, however, in fact, that can be changed to proceed with dry etching process, which also achieves the purpose of forming the insulation layer 25 and the separator 26. For example, the first insulation layer 257 and the second insulation layer 259 are formed by the wet etching process at first, wherein the second insulation layer 259 is as an intersection type with the first insulation layer 257, and then dry etching one of the insulation layers to form a separator 26.

In summary, it is appreciated that the present invention is related to an organic electroluminescent device and method of manufacturing the same, not only preventing to cause the short circuit from the abnormal contact of the opposite electrode and lower electrode, but also defining each pixel position and reducing the crosstalk noise for pixels each other.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

10 organic electroluminescent device
11 transparent substrate
13 lower electrode
15 insulation layer
151 separator
17 organic light emitting layer
171 border
19 opposite electrode
191 spilled area
20 organic electroluminescent device
21 transparent substrate
22 isolating layer
23 lower electrode
24 photoresist
241 first photoresist
243 second phtoresist
245 etching window
25 insulation layer
251 top
253 neck
255 bottom
257 first insulation layer
259 second insulation layer
26 separator
27 organic light emitting layer
29 opposite electrode

I claim:

1. An organic electroluminescent device, comprising:
a transparent substrate, comprising at least one lower electrode provided on the partial surface thereof;
at least one insulation layer convexly provided on said transparent substrate and the partial surface of said lower electrode, crossing said lower electrode and forming as an intersection type with said lower electrode;
at least one separator provided on the surface of said transparent substrate without said lower electrode and said insulation layer; and
an organic light emitting layer provided on the surface of said lower electrode without said insulation layer sheltering, further comprising an opposite electrode provided on the surface of said organic light emitting layer.

2. The organic electroluminescent device of claim 1, wherein the height of said insulation layer is higher than said separator.

3. The organic electroluminescent device of claim 1, wherein said insulation layer comprises a bottom provided on said transparent substrate and the partial surface of said lower electrode, said bottom connected to a top through a neck, wherein the action width of said top is bigger than said neck.

4. The organic electroluminescent device of claim 3, wherein the action width of the bottom of said insulation layer is bigger than said neck of said insulation layer.

5. The organic electroluminescent device of claim 3, wherein said organic light emitting layer can touch the bottom of said insulation layer.

6. The organic electroluminescent device of claim 3, wherein aid organic light emitting layer can be stacked on the partial surface of the bottom of said insulation layer.

7. The organic electroluminescent device of claim 1, wherein the surface of said insulation layer further comprises a photoresist.

8. The organic electroluminescent device of claim 1, wherein said insulation layer and said separator can be selected from one of silicon oxide, silicon nitride, nitrided silicon dioxide, polyidmide, ketoaldehyde resin, phenolic resin, and polymethyl methacrylate.

9. An organic electroluminescent device, comprising:
a transparent substrate, comprising at least one lower electrode provided on the partial surface thereof;
at least one insulation layer convexly provided on said transparent substrate and the partial surface of said lower electrode, crossing said lower electrode and forming a bottom as an intersection type with said lower electrode, said bottom thereof connected to a top through a neck, wherein the action width of said top is bigger than said neck, and the action width of said bottom is bigger than said top; and
an organic light emitting layer provided on the surface of said lower electrode without said insulation layer sheltering, further comprising an opposite electrode provided on the surface of said organic light emitting layer.

10. The organic electroluminescent device of claim 9, wherein aid organic light emitting layer can be stacked on the partial surface of the bottom of said insulation layer.

11. The organic electroluminescent device of claim 9, wherein the surface of said insulation layer further comprises a photoresist.

12. The organic electroluminescent device of claim 9, wherein further comprises a separator adjoined said lower electrode and provided on the surface of said transparent substrate.

13. The organic electroluminescent device of claim 12, wherein the height of said separator is lower than said insulation layer.

14. A method of manufacturing organic electroluminescent device, comprising the steps of:
defining and forming at least one lower electrode provided on the partial surface of a transparent substrate;
covering an isolating layer provided on the surface of said lower electrode and said transparent substrate without said lower electrode sheltering, defining and forming at least one insulation layer, which is used to be an intersection type with said lower electrode, and a separator adjoined on said lower electrode within at least one semiconductor process and providing on an isolating layer, according to a photoresist and a short wavelength light source applied; and
forming at least one organic light emitting layer and at least one opposite electrode provided on the surface of said lower electrode in order.

15. The organic electroluminescent device of claim 14, wherein the height of said separator is lower than said insulation layer, said separator provided with said insulation layer by single semiconductor process according to the attitude difference of said short wavelength light source.

16. The organic electroluminescent device of claim 14, wherein the height of said separator is lower than said insulation layer, said separator provided with said insulation layer by single semiconductor process according to a light shield corresponding to a fixed attitude of said short wavelength light source, wherein the light penetration rate of said light shield can be alternated by the position difference of light penetrating.

17. The organic electroluminescent device of claim 14, wherein the height of said separator is lower than said insulation layer by a plurality of times semiconductor process.

18. The organic electroluminescent device of claim 14, wherein said semiconductor process is a wet etching process.

19. The organic electroluminescent device of claim 14, wherein said semiconductor process can be a wet etching process with collocating a dry etching process to completely provided said insulation layer and said separator.

20. The organic electroluminescent device of claim 14, wherein said short wavelength light source is smaller than 500 nm wavelength.
